(19) United States
(12) Patent Application Publication
(10) Pub. No.: US 2006/0032716 A1
(43) Pub. Date: Feb. 16, 2006

(54) Gas spring, arrangement and method for a gas spring

(75) Inventor: Torkel Sintorn, Vaxholm (SE)

Correspondence Address: CONNOLLY BOVE LODGE & HUTZ LLP, SUITE 800, 1990 M STREET NW, WASHINGTON, DC, 20036-3425, US

(73) Assignee: Ohlins Racing AB, Upplands-Vasby (SE)

(21) Appl. No.: 11/201,091

(22) Filed: Aug. 11, 2005

(30) Foreign Application Priority Data
Aug. 11, 2004 (SE) 0402004-6

(51) Int. Cl. F16F 5/00

(52) U.S. Cl. 188/284; 267/64.11

(57) ABSTRACT

An arrangement with or in the form of a gas spring, comprising a first and second gas chamber with one or more devices separating these, which devices are arranged to increase the volume of the first chamber and reduce the volume of the second chamber, or vice versa, when a difference in pressure arises in the chamber. The invention also relates to a method for determining the spring characteristics of a gas spring, with the spring characteristics being created only by a first device, by means of which the space in the gas cylinder is divided into a first gas chamber and a second gas chamber, or in combination with a second device which is arranged in an additional chamber, which is divided by the second device into a third chamber and a fourth chamber that are connected to the first chamber and the second chamber respectively. The first or second device is arranged as a separating device that brings about an increase in the volume of the first chamber or the third chamber and a reduction in the volume of the second chamber or the fourth chamber, or vice versa, in response to a pressure difference between the first chamber and the second chamber or the third chamber and the fourth chamber. By means of the invention, a gas spring is obtained that is compact and divides up movement, and that has advantageous spring characteristics and a large gas volume.

The present invention relates, among other things, to a gas spring intended for a vehicle and comprising a gas cylinder with a piston operating in the gas cylinder that divides the cylinder into two chambers by means of at least one divider arranged between the piston and the cylinder. The invention also relates to an arrangement with or in the form of a gas spring that comprises first and second gas chambers and one or more means for separating these, and a method for determining the spring characteristics of such a gas spring.

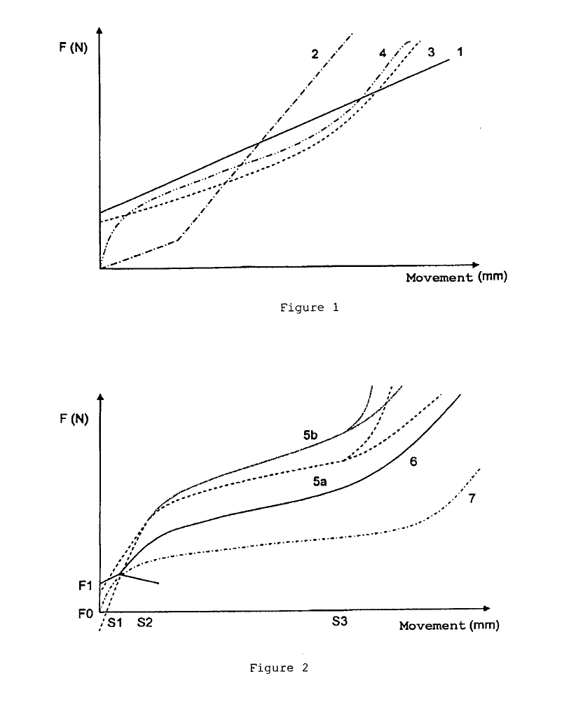

There are many ways of providing suspension for vehicles, for example using coil springs, pneumatics or hydraulics. The different suspension systems have both advantages and disadvantages, which will be described in greater detail below. A common suspension system with a linear coil spring with preloading has a build-up of forces similar to that represented by 1 in FIG. 1 below. In this case, a large force is required before the spring starts to absorb forces, meaning that the gas spring will not operate in the event of small excitations. A known solution to this problem is to use either a plurality of series-connected springs with different spring constants or a progressive spring, whereby a curve figuration 2 in FIG. 1 can be obtained. The connecting together of several coil springs results in a heavy construction that is difficult to adjust without disassembling the whole spring system. A progressive spring is also heavy and difficult to adjust and to optimize for different loads. A pneumatic spring with a single chamber has a progressive curve, see FIG. 1, curve 3, that starts at a particular preload and therefore has the same disadvantages as the single coil spring described above. The advantage of a single chamber spring is that the build-up of force is progressive, so that the spring can absorb much greater forces without bottoming. The build-up of force with a two-chamber spring is described by curve 4 in FIG. 1 which shows the case when the build-up of force starts from almost zero and then increases progressively and then levels out and then, at the end of the movement, increases progressively again. On account of the ratio between the volumes of air that are compressed in the chambers, the spring constant is initially high in the event of small movements and therefore a large force is required in order to make the spring work.

A gas spring with only one gas chamber is known through, for example U.S. Pat. No. 6,311,962 B1. The system in this patent comprises a damper unit in the form of a cylinder joined together with an external seal, which is telescopically mounted at one end in one end of a pneumatic cylinder, in a corresponding way to that described above. The difference in comparison to what is described above is that one end of the pneumatic cylinder is open and that only a space between the damping cylinder and the pneumatic cylinder is sealed. In this case, the space is sealed against the atmosphere and forms a compression chamber as a result of the external sealing of the damping cylinder.

The utilization of two-chamber pneumatic suspension systems in vehicles is also known, for example through U.S. Pat. No. 6,135,435 A which shows a system that comprises a damping cylinder that has one end mounted telescopically in one end of a pneumatic cylinder in such a way that the damper works as a piston. The other ends of the respective cylinders are fixed between the parts of the vehicle that need shock-absorbing. In order to achieve springing, the pneumatic cylinder is divided into two chambers with variable volumes, which chambers are delimited by seals. These constitute an expansion chamber and a compression chamber. When the pneumatic cylinder is subjected to an external compressive force, the air in one chamber is compressed, resulting in the pressure increasing in the chamber. In order to equalize the pressure between the two chambers and in order to avoid both the chambers needing to be pressurized, a duct is arranged in the wall of the pneumatic cylinder. The duct is only open when the pneumatic spring is almost completely expanded.

As it is desirable to achieve a suspension system that operates in the event of small rapid excitations, but that can also absorb large forces and damp large springing movements effectively, a system is required that has a low spring constant and a low pre-load, even at the start of the movement. The ideal is thus a spring system that combines the advantages of a low spring constant at the start of the movement with a progressive increase in force at the end of the movement. See FIG. 2.

In connection with gas springs and arrangements according to the invention, there is a desire to be able to adjust required characteristics of the gas spring function in accordance with the above. In the embodiment of the concept of the invention, there can be a desire to be able to select damping characteristics from among several different possible damping characteristics in order to be able to match the damping to the springing. The gas spring or the arrangement must, in certain cases, be able to be made as compact as possible, but still with technically simple and well-tried means and components. A small and compact spring with low weight is much sought after in vehicle design. There is also a desire to be able to utilize large gas volumes within or in association with the gas spring in spite of the said compactness, so that a large movement of the spring is possible.

With a gas spring of this kind, there is also a need to be able to distinguish the low and high frequency movements in the gas spring or the system which, for example, must be able to work in such a way that the gas spring deals with the movements in only one of the parts between which the gas spring function is arranged, for example the chassis. The gas spring must thus be able to be arranged in such a way that the movements of the other part are not affected; that is the gas spring or the system can work purely as a chassis control unit.

The object of the present invention is to solve all or parts of the problems described above.

The principal characteristics of a gas spring, an arrangement and a method according to the invention are apparent from the following principal claims and independent claims. Further developments of the concept of the invention according to these claims are apparent from the subsidiary claims associated with these claims.

Currently preferred embodiments of a gas spring, an arrangement and a method according to the invention will be described below with reference to the attached drawings in which:

FIG. 1 shows, in the form of diagram, known force/movement curves,

FIG. 2 shows, in the form of diagram, sought-after force/movement curves,

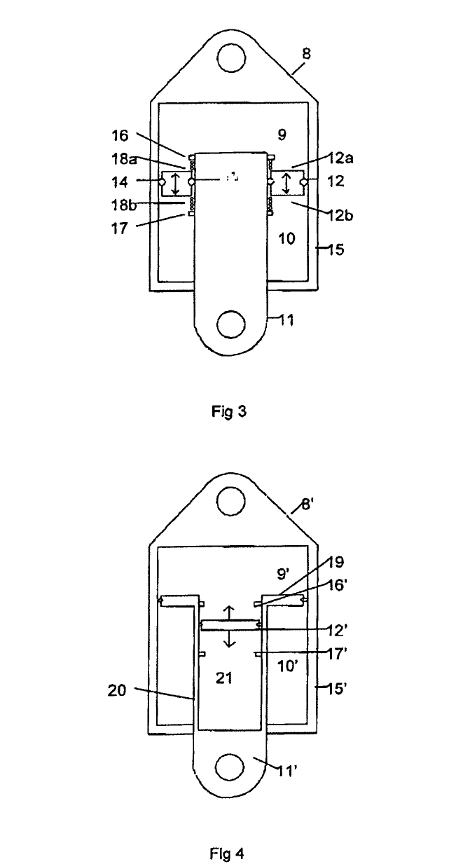

FIG. 3 shows, in vertical section and in outline, a first embodiment of a gas spring,

FIG. 4 shows, in vertical section and in outline, a second embodiment of a gas spring,

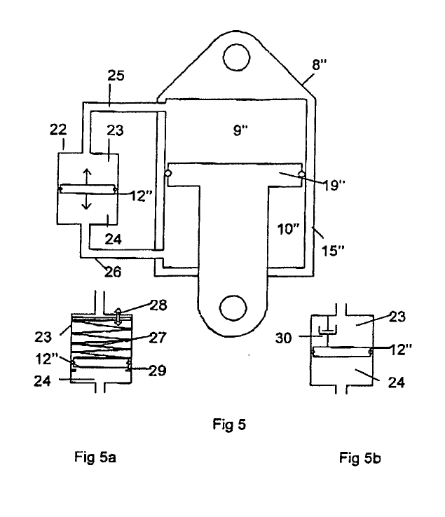

FIGS. 5-5b show, in vertical section and in outline, other embodiments of a gas spring,

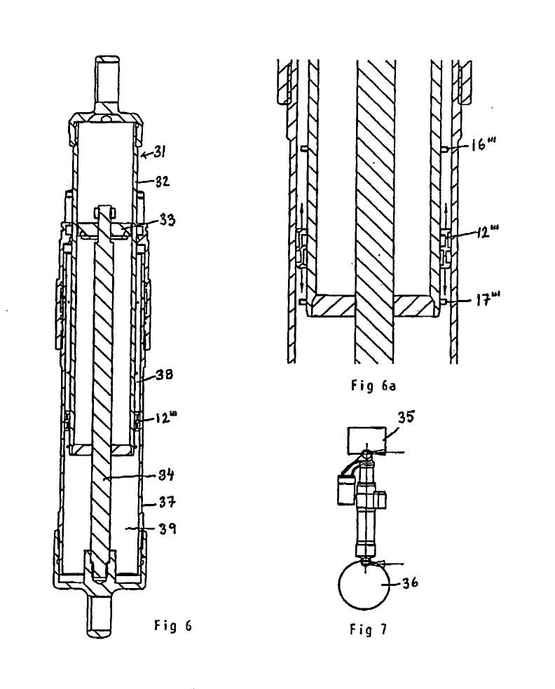

FIG. 6 shows, in vertical section, a constructive embodiment of the damper according to FIG. 3,

FIG. 6a shows, in enlarged vertical section, parts of the damper according to FIG. 4, and

FIG. 7 shows, in side view, a shock absorber with gas spring functionality attached in a vehicle that is shown in outline.

FIG. 1 has been described above. In FIG. 2, three sought-after spring curves have been drawn in. Using various solutions that are based on the same principle, a spring behaviour resembling the ideal curves can be achieved. FIG. 2 is described here together with the remaining figures that show the different design solutions.

FIG. 3 shows a simplified sketch of an embodiment of the concept of the invention. The gas spring 8 is divided into an expansion chamber 9 and a compression chamber 10 that are separated by a divider 12 arranged on a piston rod 11. The divider is sealed by internal and external seals 13, 14 against the inner surface of the cylinder 15 and the outer surface of the piston rod 11. What is specific to the invention is that the divider 12 is arranged on the piston rod 11 in such a way that it can be moved. By means of this construction, the spring constant at the start and at the end of the movement can be changed in accordance with a predetermined function and the gas spring's Force/movement curve can be described by FIG. 2 curve 5a. The divider 12 can either float freely in the gas, or—in order, in addition, to be able to control the spring constant in the middle of the movement—the divider can be spring-suspended by one or more coil springs 18a and 18b. By selecting different spring constants and different preloading of this coil spring or these coil springs 18a, 18b, the gradient of the initial curve 5a and the force F at which the spring starts to be compressed are changed. The curve 5a describes FIG. 3 when the piston floats freely and curve 5b shows the spring behaviour with only the upper spring 18a mounted. The spring has no preloading and starts to be compressed when the divider acts on the spring in the event of the movement S2. The maximum movements of the divider 12 are limited by mechanical stops 16, 17. Dependent upon where these mechanical stops 16, 17 are positioned, the force curve turns as can be seen in the curves 5a, 5b, before the movement S1 and after the movement S2 respectively. As the curve 5b describes the gas spring with the spring 18a mounted, the gradient of the curve between the movements S1 and S2 is changed depending upon the spring constant of the spring 18a. The curve 6 has a preloading of the spring which means that a force of size F1 is required in order to compress the spring; the larger the preloading, the higher the force that is required. Depending upon how much preloading the spring is given, the angle 6a in the initial part of the curve 6 is thus moved upwards or downwards on the force axis. The total spring constant and the force absorption at the start of the movement of the gas spring can thus be determined by preloading the spring that acts on the movable divider.

FIG. 4 shows an alternative embodiment of the invention in which the movable divider 12′ is placed inside the piston rod 11′. The expansion chamber 9′ and the compression chamber 10′ are delimited by a divider 19 attached to the piston rod 11′ and sealed against the outer cylinder 15′. The movable divider 12′ forms a chamber 21 in the piston rod 11′, which chamber is connected to the compression chamber 10′ by a duct 20. If the gas is able to flow freely between the chambers 21 and 10′, then the gas spring behaves in the same way as the spring described in FIG. 3. As the total volume in the spring is utilized in a different way in this alternative embodiment, the spring can, for example, be made smaller while retaining its spring characteristics. It is also possible to insert a valve or a regulator in the duct 20. By means of this device, the flow between the chambers 10′ and 21 can be adjusted. That is to say, it is possible to use the valve as a “preloading” of the spring. Also in this design, the divider can float freely or else the movement can be determined by a coil spring. The movements of the divider are also limited by stops 16′, 17′. When the duct 20 is completely open, the spring characteristics can be described by curve 7 in FIG. 2. Due to the position of the floating divider, the ratio of the volumes with which the pressure in the gas cylinder affects the areas gives a curve form that is flatter than the curves 5 and 6.

In FIG. 5, the first and second chambers are indicated by 9″ and 10″ and the fixed divider that separates the chambers is designated 19′. The movable divider 12″ is here placed in an external unit 22, where the divider 12″ divides the inner space in the unit 22 into two chambers 23, 24. The chamber 23 is interconnected with the chamber 9″ via a connecting pipe or duct 25 and the chamber 24 is interconnected with the chamber 10″ via the pipe/duct 26. Regulators and/or valves can be inserted in the ducts 25, 26 that give a delay to the flow. As the divider floats freely or is spring-suspended in a separate unit in this embodiment, the gas spring can be made smaller and more compact.

FIG. 5a shows the unit 22 with a spring 27 as the force-absorber. The preloading of the spring can be changed by means of an adjusting device 28. If required, a stop 29 can also be used to predetermine the size of the chambers 23, 24.

In FIG. 5b, the movement of the floating divider 12″ is limited by a damper unit 30. By introducing such a unit, the spring behaviour can be dependent upon speed, that is to say for rapid excitations of the gas spring the spring behaviour can be selected to be different to the spring behaviour for slow movements. In, for example, a motorcycle, the chassis moves with a frequency of approximately 1-2 Hz, while the wheels move with a frequency of around 10 Hz. On account of the different movement frequencies of the chassis and the wheels, it is therefore possible to separate the movements with the speed-dependent damper and thereby give the different movements separate spring behaviours.

A damper unit can, of course, also be combined with a spring that is inserted between the divider 12, 12′ and the stops 16, 16′, 17, 17′ in one or both directions in the design solutions according to FIGS. 3 and 4.

The gas spring function can be combined with other functions in a unit or in an arrangement, of which the shock-absorber function constitutes one embodiment. Such an embodiment of the invention is described in FIGS. 6 and 7. The gas spring unit according to FIG. 7 is attached between two parts of the vehicle in question (that is a car, motorcycle, scooter, boat, aeroplane, etc,) with the parts in this figure corresponding to a chassis 35 and a wheel 36. The embodiment in FIG. 6 is based on the solution according to FIG. 3, but instead of having a solid piston rod, in this solution a damper unit 31 replaces the piston rod. The damper unit 31 comprises a damping cylinder 32, a damping piston 33 and a piston rod 34. The upper part of the damping cylinder 32 is attached to the chassis 35 and, at the other end of the gas spring, the piston rod 34 and the outer cylinder 37 are attached to the wheels 36. The floating divider 12′″ is placed between the damping cylinder 32 and the outer cylinder 37, so that the space above the divider 12′″ forms an expansion chamber 38 and the space below the divider 12′″ forms a compression chamber 39. The movements of the floating divider 12′″ are limited by upper and lower mechanical stops 16′″, 17′″. If a spring is placed between the stops and the divider, then this embodiment of the invention has a Force/movement curve that resembles curve 5b in FIG. 2; without a spring, curve 5a is obtained.

In a method for determining the spring characteristics for a gas spring, this is carried out with a gas cylinder, with the spring characteristics being created only by a first device, by means of which the space in the gas cylinder is divided into a first gas chamber and a second gas chamber, or in combination with a second device which is arranged in an additional chamber, which is divided by the second device into a third chamber and a fourth chamber that are connected to the first chamber and the second chamber respectively. The first or second device is arranged as a separating device that brings about an increase in the volume of the first chamber or the third chamber and a reduction in the volume of the second chamber or the fourth chamber, or vice versa, in response to a pressure difference between the first chamber and the second chamber or the third chamber and the fourth chamber.

In an embodiment, the movable first or second device/divider can be replaced by a membrane and/or flexible device or by third and fourth chambers that are not connected, the volumes of which are controlled by computer (microcomputer). The increase and reduction in volume can thus be brought about using devices that are not arranged to be moveable. The separating device(s)/divider(s) can be provided with shimming.

The invention is not limited to the embodiments described above as examples, but can be modified within the framework of the following patent claims and concept of the invention.

The separating device(s) 12, 12′, 12″, 12′″ are thus arranged to be able to be moved longitudinally relative to a piston 11 or other movable unit 31 arranged in the gas cylinder 15, 37, in response to pressure differences that have arisen in the first and second volumes created by the separating device, by the separating devices 12, 12′, 12″, 12′″ being arranged to maintain a seal between the chambers during the respective relative movement.

1. Gas spring intended for a vehicle and comprising a gas cylinder with a piston operating in the gas cylinder that divides the cylinder into two chambers by means of at least one divider arranged between the piston and the cylinder, wherein the divider functioning between the gas cylinder and the divider functioning between the gas cylinder and the piston is arranged to be able to be moved relative to the piston and/or the cylinder in a direction parallel to the direction of operation of the gas cylinder.

2. Gas spring according to claim 1, wherein the divider is arranged to be able to be moved in a longitudinal direction in both the compression direction and the expansion direction.

3. Arrangement with or in the form of a gas spring that comprises first and second gas chambers and one or more separating devices for separating the first and second gas chambers wherein the separating device(s) are arranged to increase the volume of the first chamber and to reduce the volume of the second chamber, or vice versa, when a difference in pressure arises in the chamber.

4. Arrangement according to claim 3, wherein the gas spring comprises a gas cylinder, a piston arranged in this that can have an associated piston rod, and a separating device arranged between the inner wall of the cylinder and the outer wall of the piston, wherein the separating device is arranged to be able to be moved in a longitudinal direction relative to the piston and/or the cylinder in response to pressure differences that have arisen in the first and second volumes created by the separating device.

5. Arrangement according to claim 4, wherein the maximum sizes of the longitudinal movements are determined by means of mechanical stops.

6. Arrangement according to claim 4, wherein the longitudinal movements in one or both directions are arranged to be carried out against a resistance in the form of a spring and/or damping device.

7. Arrangement according to claim 3, wherein the gas spring comprises a gas cylinder and a piston operating in the gas cylinder, and wherein the space inside the piston comprises a divider separating the first and the second volumes and acting as a device that can be moved longitudinally.

8. Arrangement according to claim 7, wherein the movements of the divider in one or both directions are determined by means of mechanical stops and/or resistances in the form of spring devices and/or damping devices.

9. Arrangement according to claim 3, wherein the gas spring comprises a gas cylinder and a piston inside this that can be provided with a piston rod, which piston divides the space inside the gas cylinder into the first and second chambers, and wherein the first and second chambers are connected to third and fourth chambers respectively, wherein the third and fourth chambers are achieved by means of a divider or a second piston acting as a separating device that is arranged to be able to be moved longitudinally in an additional gas cylinder.

10. Arrangement according to claim 9, wherein the divider or the second piston is able to be moved in one or both longitudinal directions against a resistance in the form of a spring device or a damping device.

11. Arrangement according to claim 6, wherein in the case with a resistance in the form of a spring device, the arrangement or the spring device is arranged to be able to be preloaded by means of an adjusting device.

12. Arrangement according to any one of claim 3, wherein the gas spring is connected to two parts of the vehicle that move in relation to each other, wherein the gas spring is arranged in its control function to take into account only the movements of one of the two parts.

13. Arrangement according to any one of claim 3, it wherein the arrangement is arranged to respond to small and rapid movements and is able to absorb large forces and damp large spring movements by having a low spring constant at the start of the respective movement, with progressive or levelled-out increase in force at the end of the movement.

14. Arrangement according to claim 13, wherein the gas spring is arranged to be able to work with a coil spring in an actual suspension, and wherein the gas spring is arranged to absorb forces progressively or essentially horizontally linearly at the end of the coil spring's linear force-absorbing of area for the purpose of increasing the size of the movement.

15. Arrangement according to claim 3, wherein the one or more separating device or devices are in the form of movable devices including membranes and/or flexible devices.

16. Method for determining the spring characteristics of a gas spring wherein the gas spring of comprises a gas cylinder, and wherein the damping characteristic or damping characteristics are created only by means of a first device including a first piston provided with a piston rod, by means of which piston the space in the gas cylinder is divided into first and second gas chambers, or in combination with a second device including a second piston or divider that is arranged in an additional chamber which is divided by the second device or the second piston or divider into a third chamber and fourth chamber that are connected to the first chamber and the second chamber respectively, wherein the first and second devices are arranged as separating devices that bring about an increase in the volume of the first chamber or the third chamber and a reduction in the volume of the second chamber or the fourth chamber, or vice versa, in response to a difference in pressure between the first chamber and the second chamber or the third chamber and the fourth chamber.

17. Method according to claim 16, wherein the first device consists of a piston arranged on a piston rod, wherein the piston is moved relative to the piston rod while maintaining a seal.

18. Arrangement according to claim 8, wherein in the case with a resistance in the form of a spring device, the arrangement or the spring device is arranged to be able to be preloaded by means of an adjusting device.

19. Arrangement according to claim 10, wherein in the case with a resistance in the form of a spring device, the arrangement or the spring device is arranged to be able to be preloaded by means of an adjusting device.

20. Arrangement according to claim 4, wherein the gas spring is connected to two parts of the vehicle, for example the chassis and the wheels, that move in relation to each other, wherein the gas spring is arranged in its control function to take into account only the movements of one of the two parts.
